(19) United States
(12) Patent Application Publication
(10) Pub. No.: US 2013/0033123 A1
(43) Pub. Date: Feb. 7, 2013

(54) THETA Z DRIVE APPARATUS AND STAGE APPARATUS

(71) Applicant: KABUSHIKI KAISHA YASKAWA DENKI, Kitakyushu-shi (JP)

(72) Inventors: Yoshiaki KUBOTA, Kitakyushu-shi (JP); Toru SHIKAYAMA, Kitakyushu-shi (JP); Yoichiro DAN, Kitakyushu-shi (JP); Toshiyuki KONO, Kitakyushu-shi (JP); Akihito TOYODA, Kitakyushu-shi (JP)

(73) Assignee: KABUSHIKI KAISHA YASKAWA DENKI, Kitakyushu-shi (JP)

(21) Appl. No.: 13/645,796

(22) Filed: Oct. 5, 2012

Related U.S. Application Data
(63) Continuation of application No. PCT/JP2010/072075, filed on Dec. 9, 2010.

(30) Foreign Application Priority Data
Apr. 7, 2010 (JP) 2010-088272

(51) Int. Cl. H02K 41/02

(52) U.S. Cl. 310/12.06

(57) ABSTRACT

In this θZ drive apparatus, at least three coil portions are arranged to be capable of driving a stage in a direction Z, a direction θx which is a rotation direction employing a direction X in a horizontal plane as a center line of rotation, and a direction θy which is a rotation direction employing a direction Y in the horizontal plane orthogonal to the direction X as a center line of rotation.

### CROSS-REFERENCE TO RELATED APPLICATIONS

The priority application number JP2010-088272, θZ Drive Apparatus and Stage Apparatus, Apr. 7, 2010, Yoshiaki Kubota, Toru Shikayama, Yoichiro Dan, and Toshiyuki Kono, upon which this patent application is based is hereby incorporated by reference. This application is a continuation of PCT/JP2010/072075, θZ Drive Apparatus and Stage Apparatus, Dec. 9, 2010, Yoshiaki Kubota, Toru Shikayama, Yoichiro Dan, Toshiyuki Kono, and Akihito Toyoda.

### BACKGROUND OF THE INVENTION

1. Field of the Invention

The present invention relates to a θZ drive apparatus and a stage apparatus, and more particularly, it relates to a θZ drive apparatus and a stage apparatus each including a stage driven in the vertical direction (direction Z) and a rotation direction (direction θz).

2. Description of the Background Art

In general, a θZ drive apparatus and a stage apparatus each including a stage driven in the vertical direction (direction Z) and a rotation direction (direction θz) is known, as disclosed in Japanese Patent Laying-Open No. 2007-027659, for example.

In a θZ drive portion of a stage apparatus according to the aforementioned Japanese Patent Laying-Open No. 2007-027659, a θz drive actuator (voice coil motor) is provided, and this θz drive actuator is configured to be capable of rotating a stage within a range of ±2 degrees about an axis in a direction Z (in a direction θz). Furthermore, in the θZ drive portion, a pair of Z-axis actuators (voice coil motors) are provided to be opposed to each other through the stage, and this Z-axis actuators are configured to move up and down the stage in the direction Z. Thus, the θZ drive portion of the stage apparatus according to Japanese Patent Laying-Open No. 2007-027659 is configured to be capable of driving the stage in the direction Z and the direction θz by the Z-axis actuators and the θz drive actuator.

Such a stage apparatus is employed to position a substrate such as a semiconductor wafer accurately with respect to an optical system device provided in an exposure apparatus, a semiconductor inspection apparatus, or the like in the field of semiconductor manufacturing. Meanwhile, in recent years, the substrate such as a semiconductor wafer tends to be thinned and increased in diameter, and warpage or distortion is easily generated in such a substrate. If warpage or the like is generated in the substrate placed on a stage through a substrate holding mechanism, the substrate is slightly inclined with respect to the optical system device. When the stage apparatus (θZ drive apparatus) is employed for an exposure apparatus, a semiconductor inspection apparatus, or the like, the accuracy of positioning the substrate at a level of a few nanometers is required. Therefore, even if the substrate is slightly inclined with respect to a horizontal plane, the inclination may interfere with process such as exposure, inspection, or the like.

However, although the θZ drive portion of the stage apparatus according to the aforementioned Japanese Patent Laying-Open No. 2007-027659 can drive the stage in the direction Z and the direction θz, the same cannot drive the stage in a direction θx and a direction θy about respective axes in a direction X and a direction Y orthogonal to each other in a horizontal plane. Therefore, when a substrate placed on the stage is slightly inclined with respect to the horizontal plane, there is such a problem that the stage cannot be driven to adjust the inclination thereof. Furthermore, in the aforementioned Japanese Patent Laying-Open No. 2007-027659, a mechanism performing driving in the direction θx and the direction θy may be added, but in this case, such a problem that the apparatus increases in size may newly arise.

### SUMMARY OF THE INVENTION

The present invention has been proposed in order to solve the aforementioned problems, and an object of the present invention is to provide a θZ drive apparatus and a stage apparatus each capable of adjusting an inclination of a stage with respect to a horizontal plane while suppressing increase in the size of the apparatus.

In order to attain the aforementioned object, a θZ drive apparatus according to a first aspect includes a base portion, a stage driven in a direction Z which is a vertical direction with respect to the base portion and in a direction θz which is a rotation direction employing the direction Z as a center line of rotation, and a single actuator driving the stage at least in the direction Z with respect to the base portion, while the single actuator includes a movable element having a plurality of permanent magnets and a stator provided to be opposed to the permanent magnets in a horizontal direction, having a Z-direction drive coil to drive the stage in the direction Z, the Z-direction drive coil of the single actuator is divided into at least three coil portions capable of being supplied with current independently of each other, and the at least three coil portions are arranged to be capable of driving the stage in the direction Z, a direction θx which is a rotation direction employing a direction X in a horizontal plane as a center line of rotation, and a direction θy which is a rotation direction employing a direction Y in the horizontal plane orthogonal to the direction X as a center line of rotation.

In this θZ drive apparatus according to the first aspect, as hereinabove described, the Z-direction drive coil of the single actuator is divided into the at least three coil portions capable of being supplied with current independently of each other, and the at least three coil portions are arranged to be capable of driving the stage in the direction Z, the direction θx which is the rotation direction employing the direction X in the horizontal plane as a center line of rotation, and the direction θy which is the rotation direction employing the direction Y in the horizontal plane orthogonal to the direction X as a center line of rotation, whereby the stage can be driven in the direction Z, the direction θx which is the rotation direction employing the direction X in the horizontal plane as a center line of rotation, and the direction θy which is the rotation direction employing the direction Y in the horizontal plane orthogonal to the direction X as a center line of rotation in response to current independently supplied to the at least three coil portions. Thus, even if a substrate placed on the stage through a substrate holding mechanism is slightly inclined with respect to the horizontal plane, the actuator can adjust the inclination of the stage (substrate) with respect to the horizontal plane. Furthermore, the single actuator can drive the stage in the direction θx and the direction θy in addition to the direction Z, and hence increase in the size of the apparatus can be suppressed even if a mechanism performing driving in the direction θx and the direction θy is added. Therefore, in this θZ drive apparatus according to the first aspect, the inclination of the stage with respect to the horizontal plane can be adjusted while increase in the size of the apparatus is suppressed.

A stage apparatus according to a second aspect includes a θZ drive portion, an X-direction drive portion driving the θZ drive portion in a direction X in a horizontal plane, and a Y-direction drive portion driving the θZ drive portion in a direction Y in the horizontal plane orthogonal to the direction X, while the θZ drive portion includes a base portion, a stage driven in a direction Z which is a vertical direction with respect to the base portion and in a direction θz which is a rotation direction employing the direction Z as a center line of rotation, and a single actuator driving the stage at least in the direction Z with respect to the base portion, the single actuator includes a movable element having a plurality of permanent magnets and a stator provided to be opposed to the permanent magnets in a horizontal direction, having a Z-direction drive coil to drive the stage in the direction Z, the Z-direction drive coil of the single actuator is divided into at least three coil portions capable of being supplied with current independently of each other, and the at least three coil portions are arranged to be capable of driving the stage in the direction Z, a direction θx which is a rotation direction employing the direction X in the horizontal plane as a center line of rotation, and a direction θy which is a rotation direction employing the direction Y in the horizontal plane orthogonal to the direction X as a center line of rotation.

In this stage apparatus according to the second aspect, as hereinabove described, the Z-direction drive coil of the single actuator of the θZ drive portion is divided into the at least three coil portions capable of being supplied with current independently of each other, and the at least three coil portions are arranged to be capable of driving the stage in the direction Z, the direction θx which is the rotation direction employing the direction X in the horizontal plane as a center line of rotation, and the direction θy which is the rotation direction employing the direction Y in the horizontal plane orthogonal to the direction X as a center line of rotation, whereby the stage of the θZ drive portion can be driven in the direction Z, the direction θx which is the rotation direction employing the direction X in the horizontal plane as a center line of rotation, and the direction θy which is the rotation direction employing the direction Y in the horizontal plane orthogonal to the direction X as a center line of rotation in response to current independently supplied to the at least three coil portions. Thus, even if a substrate placed on the stage through a substrate holding mechanism is slightly inclined with respect to the horizontal plane, the actuator of the θZ drive portion can adjust the inclination of the stage (substrate) with respect to the horizontal plane. Furthermore, the single actuator can drive the stage in the direction θx and the direction θy in addition to the direction Z, and hence increase in the size of the apparatus can be suppressed even if a mechanism performing driving in the direction θx and the direction θy is added. Therefore, in this stage apparatus according to the second aspect, the inclination of the stage of the θZ drive portion with respect to the horizontal plane can be adjusted while increase in the size of the apparatus is suppressed.

### BRIEF DESCRIPTION OF THE DRAWINGS

FIG. 1 is a perspective view showing the overall structure of an XYθZ stage including a θZ stage unit according to a first embodiment;

FIG. 2 is a longitudinal sectional view showing the internal structure of the θZ stage unit of the XYθZ stage according to the first embodiment shown in FIG. 1;

FIG. 3 is a perspective view showing the internal structure of the θZ stage unit of the XYθZ stage according to the first embodiment shown in FIG. 1;

FIG. 4 is a perspective view schematically showing the structure of the θZ stage unit according to the first embodiment shown in FIG. 3, from which a frame and a rotary table are removed;

FIG. 5 is an internal plan view for illustrating the internal structure of the θZ stage unit according to the first embodiment shown in FIG. 2;

FIG. 6 is an enlarged longitudinal sectional view schematically showing a stator and a movable element of an actuator employed in the θZ stage unit according to the first embodiment shown in FIG. 2;

FIG. 7 is an enlarged plan view schematically showing the stator and the movable element of the actuator shown in FIG. 6;

FIG. 8 is a perspective view for illustrating a θ drive coil and a Z drive coil of the actuator employed in the θZ stage unit according to the first embodiment shown in FIG. 2;

FIG. 9 is a diagram for illustrating the structure of each coil portion of the Z drive coil shown in FIG. 8;

FIG. 10 is a schematic view for illustrating drivers to drive the actuator employed in the θZ stage unit according to the first embodiment shown in FIG. 2;

FIG. 11 is a perspective view for illustrating the stator and the movable element of the actuator employed in the θZ stage unit according to the first embodiment shown in FIG. 2;

FIG. 12 is an enlarged longitudinal sectional view showing a weight compensation portion of the θZ stage unit according to the first embodiment shown in FIG. 2;

FIG. 13 is a longitudinal sectional view showing the internal structure of a θZ stage unit of a XYθZ stage according to a second embodiment;

FIG. 14 is an enlarged longitudinal sectional view schematically showing a stator and a movable element of an actuator employed in the θZ stage unit according to the second embodiment shown in FIG. 13;

FIG. 15 is a perspective view for illustrating a 0 drive coil and a Z drive coil of the actuator employed in the θZ stage unit according to the second embodiment shown in FIG. 13; and

FIG. 16 is a schematic view for illustrating drivers to drive the actuator employed in the θZ stage unit according to the second embodiment shown in FIG. 13.

### DESCRIPTION OF THE EMBODIMENTS

Embodiments are now described on the basis of the drawings.

### First Embodiment

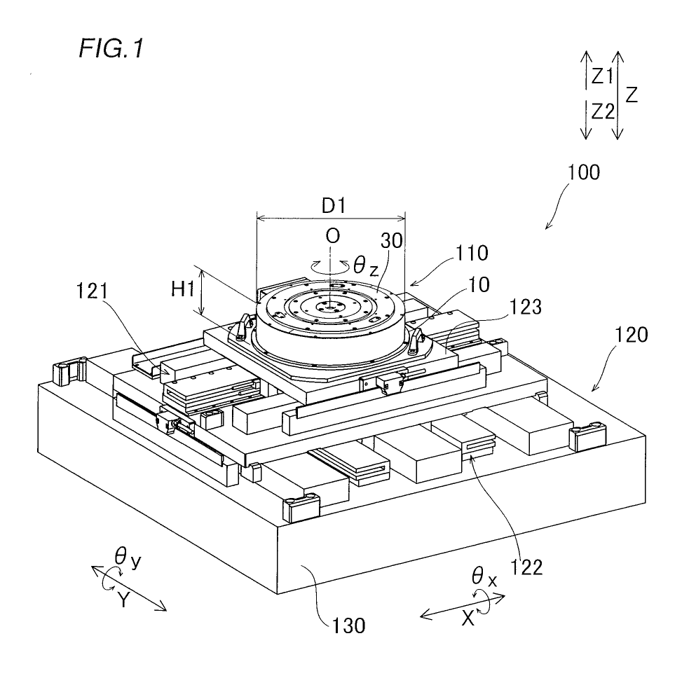

First, the structure of an XYθZ stage 100 including a θZ stage unit 110 according to a first embodiment is described with reference to FIGS. 1 to 12. In the first embodiment, an example of applying the present invention to the six-axis XYθZ stage 100 including the θZ stage unit 110 employed as a stage to position an exposure apparatus, an inspection apparatus, or the like for a semiconductor wafer is described. The θZ stage unit 110 is an example of the “θZ drive apparatus” or the “θZ drive portion”, and the XYθZ stage 100 is an example of the “stage apparatus”.

As shown in FIG. 1, the XYθZ stage 100 according to the first embodiment is mounted on a surface plate 130 hardly affected by disturbance. The XYθZ stage 100 includes the θZ stage unit 110 and an XY stage unit 120. The θZ stage unit 110 is a unit to perform positioning (positioning in a direction Z and a direction θz) of a semiconductor wafer or the like placed on a stage 30 by driving the stage 30 in the vertical direction (direction Z) and a rotation direction (direction θz) about a vertical central axis (O, direction Z). According to the first embodiment, the θZ stage unit 110 is configured to be capable of driving the stage 30 while finely adjusting an inclination of the stage 30 with respect to a horizontal plane shown by combination of a direction θx which is a rotation direction employing a direction X in the horizontal plane as a center line of rotation and a direction θy which is a rotation direction employing a direction Y in the horizontal plane orthogonal to the direction X as a center line of rotation in addition to the direction Z and the direction θz.

The XY stage unit 120 is provided on the surface plate 130 and configured to be capable of moving a movable portion 123 in the direction X and the direction Y. The XY stage unit 120 includes an X-direction drive portion 121 and a Y-direction drive portion 122 each consisting of a linear motor etc. The Y-direction drive portion 122 is configured to move the θZ stage unit 110 and the X-direction drive portion 121 in the direction Y by linearly moving a movable portion fixed to the X-direction drive portion 121 in the direction Y. Thus, the XY stage unit 120 is configured to be capable of arranging (positioning) the θZ stage unit 110 at a prescribed position in a direction X-Y by moving the θZ stage unit 110 in the direction X and the direction Y. In the first embodiment, the publicly known structure can be employed in the XY stage unit 120. Therefore, the detailed description of the XY stage unit 120 is omitted.

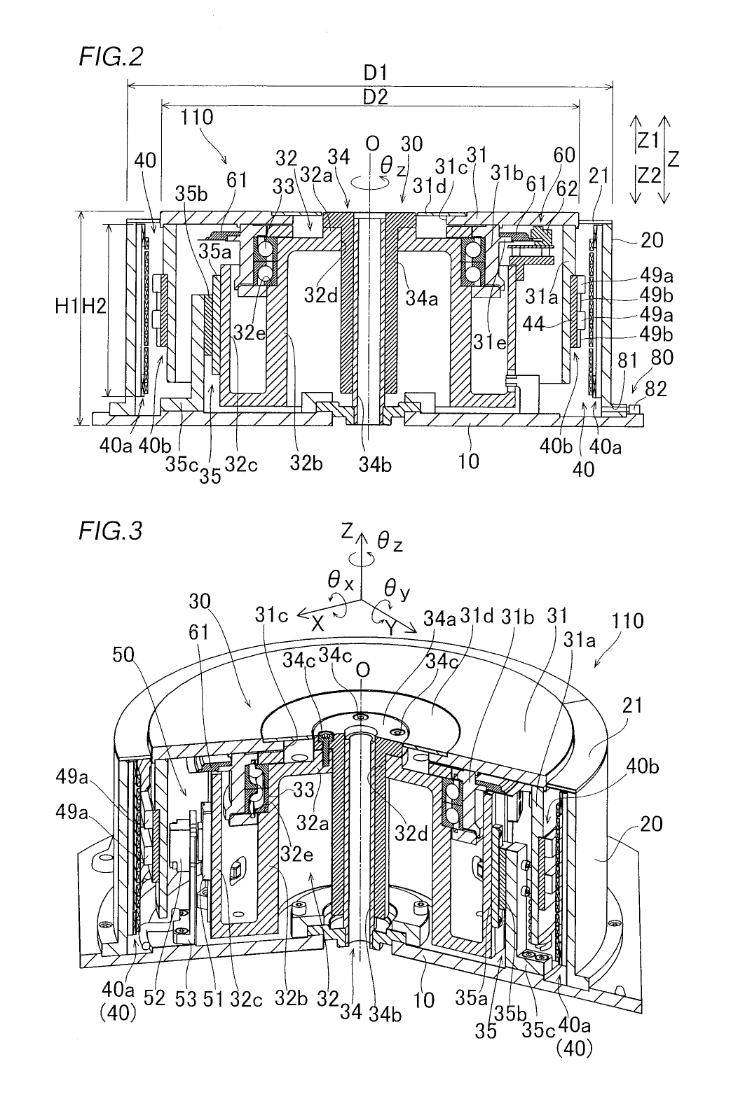

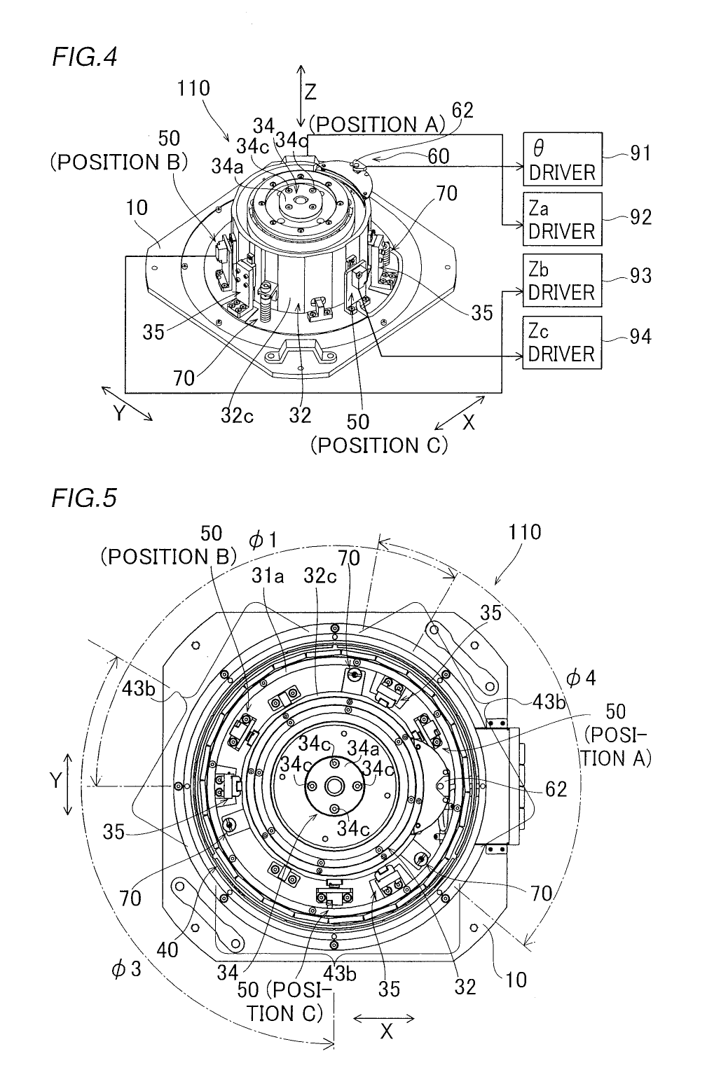

The structure of the θZ stage unit 110 is now described in detail. As shown in FIG. 1, the θZ stage unit 110 is in the form of a substantially circular plate having a diameter D1 and a height range H1. As shown in FIG. 2, the θZ stage unit 110 includes a base portion 10, a frame 20, the stage 30 having an upper surface on which a substrate holding mechanism (not shown) or the like to hold a substrate such as a semiconductor wafer is placed, a single actuator 40 driving the stage 30, up/down movement detecting portions 50 (see FIG. 3) to detect the position of the stage 30 in the vertical direction (direction Z), a rotation detecting portion 60 to detect the position of the stage 30 in the rotation direction (direction θz), weight compensation portions 70 (see FIG. 4), and an exhaust mechanism 80. The up/down movement detecting portions 50 are examples of the “Z-direction position detecting portions”.

The base portion 10 is fixedly provided on the movable portion 123 (see FIG. 1) of the XY stage unit 120 (see FIG. 1) and serves as a base on which parts of the θZ stage unit 110 are arranged. The base portion 10 is larger than the stage 30 and formed in a substantially rectangular shape in plan view, as shown in FIGS. 4 and 5. This base portion 10 constitutes the lower surface side of the θZ stage unit 110.

As shown in FIGS. 2 and 3, the frame 20 has a cylindrical shape and is fixedly set on the base portion 10. The frame 20 constitutes the outer surface portion of the θZ stage unit 110. A cover 21 made of an annular plate member is provided on an upper end of the frame 20. The cover 21 is provided to extend from the upper end of the frame 20 toward the center (stage 30) and to form a small gap between the frame 20 and a rotary table 31, described later, of the stage 30. In FIGS. 2 and 3, the cover 21 and the rotary table 31 are illustrated so as to substantially come into contact with each other.

The stage 30 is in the form of a circular plate (see FIG. 2) having a diameter D2 and includes the rotary table 31 constituting the upper surface side of the θZ stage unit 110 and an elevating table 32 supporting the rotary table 31 to be rotatable in the direction θz. The stage 30 is regulated so as to be movable in the vertical direction (direction Z) and the rotation direction (direction θz) about the central axis O (Z-axis) by a first guide portion 34 and second guide portions 35 described later and unmovable in the direction X-Y (see FIG. 1). The stage 30 is configured to be capable of being driven in the vertical direction (direction Z) and the rotation direction (direction θz) with respect to the base portion 10 by the actuator 40 as well as in directions (directions θx and θy) inclined with respect to the base portion 10. As described later, the stage 30 is so configured that only the rotary table 31 moves when the stage 30 is driven in the rotation direction (direction θz) whereas the rotary table 31 and the elevating table 32 integrally move when the stage 30 is driven in the vertical direction (direction Z).

As described above, the upper surface and the lower surface of the θZ stage unit 110 are constituted by the rotary table 31 and the base portion 10 of the stage 30, respectively, and all of the elevating table 32, the actuator 40, the up/down movement detecting portions 50, the rotation detecting portion 60, the weight compensation portions 70, and the exhaust mechanism 80 are arranged in the height range H1 in the vertical direction (direction Z) between the upper surface of the rotary table 31 and the lower surface of the base portion 10. Furthermore, the θZ stage unit 110 is so configured that the heights of parts including the elevating table 32, the up/down movement detecting portions 50, the rotation detecting portion 60, the weight compensation portions 70, and the exhaust mechanism 80 fall within an arrangement height range H2 of the actuator 40. Thus, the height (overall height) of the θZ stage unit 110 is reduced and the entire apparatus is downsized.

The rotary table 31 has an annular shape in plan view and is so arranged that the outer periphery thereof is surrounded by the annular cover 21 provided on the frame 20. The substrate holding mechanism (not shown) is mounted on the upper surface of this rotary table 31, and the unshown substrate such as a semiconductor wafer is held through the substrate holding mechanism (not shown). A hole 31c is formed in a central portion of the rotary table 31, and the rotary table 31 is formed to surround the first guide portion 34 described later in plan view. A cover 31d is provided to cover a gap between the hole 31c and the first guide portion 34. The rotary table 31 includes a cylindrical holding portion 31a protruding downward (along arrow Z2) in the outermost periphery and a substantially cylindrical mounting portion 31b protruding downward inside (on the center side beyond) the holding portion 31a.

A movable element 40b, described later, of the actuator 40 is fixedly mounted on the holding portion 31a at a prescribed height position of the outer periphery. A bearing 33 is fitted into the inner periphery of the mounting portion 31b having a concave section. The mounting portion 31b of the rotary table 31 is supported by a supporting portion 32e of the elevating table 32 through this bearing 33 so as to be rotatable in the direction θz. Thus, the rotary table 31 can rotate in the direction θz with respect to the elevating table 32.

The elevating table 32 engages with the first guide portion 34 provided in a central portion of the θZ stage unit 110 and the second guide portions 35 provided to surround the periphery of the elevating table 32 so as to be movable in the vertical direction and unmovable in the rotation direction (direction θz), as shown in FIGS. 4 and 5. The elevating table 32 integrally includes a shaft receiving portion 32a extending outward from the center side of the θZ stage unit 110, an inner cylindrical portion 32b having a cylindrical shape extending downward (along arrow Z2) from the outer periphery of the shaft receiving portion 32a, and an outer cylindrical portion 32c having a cylindrical shape extending outward from a lower end of the inner cylindrical portion 32b and thereafter being folded and protruding upward (along arrow Z1), as shown in FIG. 2. A spline 34a of the first guide portion 34 is fixedly mounted on the shaft receiving portion 32a while inserted into a hole 32d. The supporting portion 32e having a concave shape to hold the aforementioned bearing 33 is formed on an upper end of the inner cylindrical portion 32b. This supporting portion 32e of the inner cylindrical portion 32b supports the bearing 33 and the rotary table 31. The outer cylindrical portion 32c constitutes the outer periphery of the elevating table 32. Slide rails 35a (see FIG. 3) of the second guide portions 35 etc. are fixedly mounted on this outer cylindrical portion 32c.

The first guide portion 34 includes the spline 34a fixedly mounted on the shaft receiving portion 32a of the elevating table 32 with screws 34c and a spline shaft 34b fixedly provided to protrude upward (along arrow Z1) from the base portion 10 in the central portion of the θZ stage unit 110, as shown in FIGS. 2 and 3. The spline shaft 34b is inserted into the spline 34a, and the spline 34a is regulated so as to be movable in the vertical direction (direction Z) and unrotatable in the rotation direction (direction θz) with respect to the spline shaft 34b. Thus, the first guide portion 34 regulates the elevating table 32 mounted with the spline 34a to be movable in the vertical direction (direction Z) and unrotatable in the rotation direction (direction θz) in the central portion of the θZ stage unit 110.

The three second guide portions 35 are provided on the periphery of the elevating table 32 at equal rotation angular intervals of an angle φ1 (about 120 degrees) in plan view and arranged in a region (see FIG. 3) between the outer cylindrical portion 32c of the elevating table 32 and the holding portion 31a of the rotary table 31, as shown in FIG. 5. The three second guide portions 35 each have the same structure. More specifically, the second guide portions 35 include the linear slide rails 35a provided on the outer periphery of the outer cylindrical portion 32c of the elevating table 32 to extend in the vertical direction (direction Z) and guide blocks 35b fixed to the base portion 10 through brackets 35c, as shown in FIG. 3. The slide rails 35a and the guide blocks 35b engage with each other so as to be relatively movable only in the extensional direction (direction Z) of the slide rails 35a. Consequently, the elevating table 32 provided with the movable slide rails 35a is regulated by the three second guide portions 35 so as to be movable in the vertical direction and unmovable in the rotation direction (direction θz).

Thus, the elevating table 32 is regulated by the first guide portion 34 in the central portion and the three second guide portions 35 on the outer periphery so as to be movable in the vertical direction and unmovable in the rotation direction (direction θz). A shaft (first guide portion 34) is provided at the center of the elevating table 32, whereby rigidity with respect to external force (moment) in inclined directions (directions θx and θy) with respect to the horizontal plane can be increased while the outer periphery of the elevating table 32 is stopped by (engaged with) the three second guide portions 35, whereby rigidity with respect to external force (moment) in the rotation direction (direction θz) can be increased.

Thus, in the stage 30, the rotary table 31 supported through the bearing 33 is independently driven during rotation (movement in the direction θz), and the elevating table 32 and the rotary table 31 regulated (guided) by the first guide portion 34 and the second guide portions 35 are integrally driven during up/down movement (movement in the direction Z).

According to the first embodiment, the actuator 40 is annularly arranged throughout the entire circumference of the θZ stage unit 110 in the vicinity of the outer periphery of the stage 30 (inside the frame 20), as shown in FIGS. 2 and 3. The actuator 40 includes a stator 40a fixedly provided on the inner periphery of the frame 20 and the movable element 40b fixedly provided on the outer periphery of the holding portion 31a of the rotary table 31. The stator 40a and the movable element 40b of the actuator 40 are arranged to be opposed to each other at a prescribed interval in a radial direction (horizontal direction).

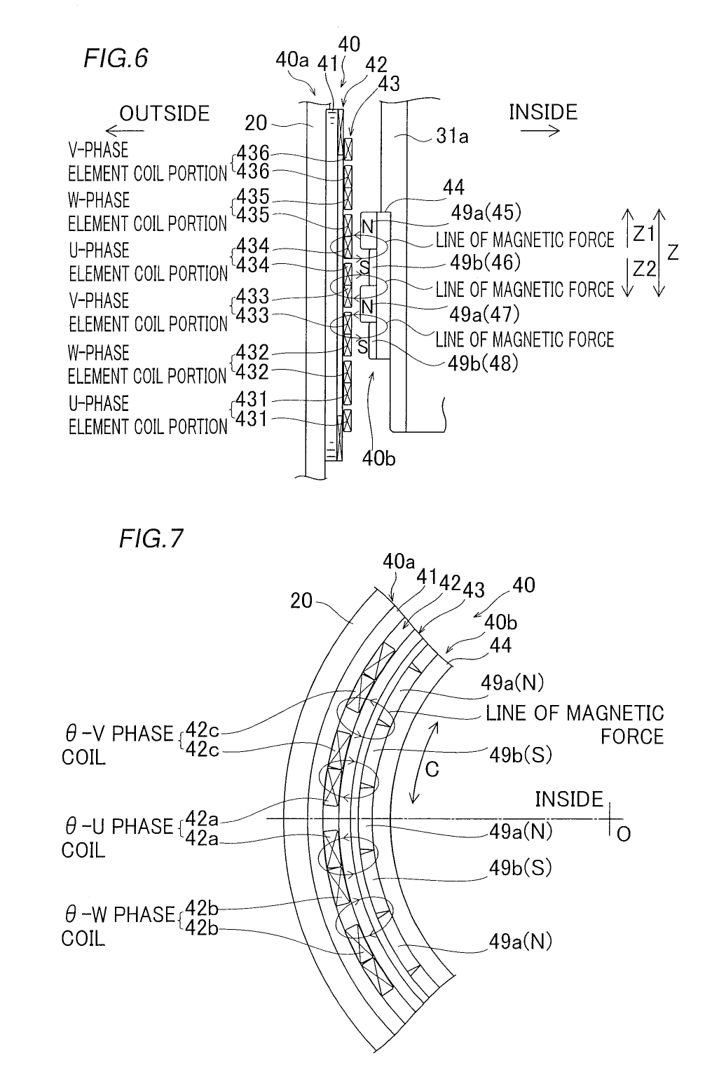

As shown in FIGS. 6 and 7, the stator 40a includes a core 41, a θ drive coil 42 to rotationally drive the stage 30 (rotary table 31) in the direction θz, and a Z drive coil 43 to drive the stage 30 in the direction Z. The core 41, the θ drive coil 42, and the Z drive coil 43 are integrally bonded to each other through unshown insulating papers. The θ drive coil 42 and the Z drive coil 43 are examples of the “θz-direction drive coil” and the “Z-direction drive coil”, respectively.

The core 41 is formed by stacking electromagnetic steel sheets and has a cylindrical shape. The core 41 is fixed by engaging the outer periphery of the core 41 with the inner periphery of the cylindrical frame 20.

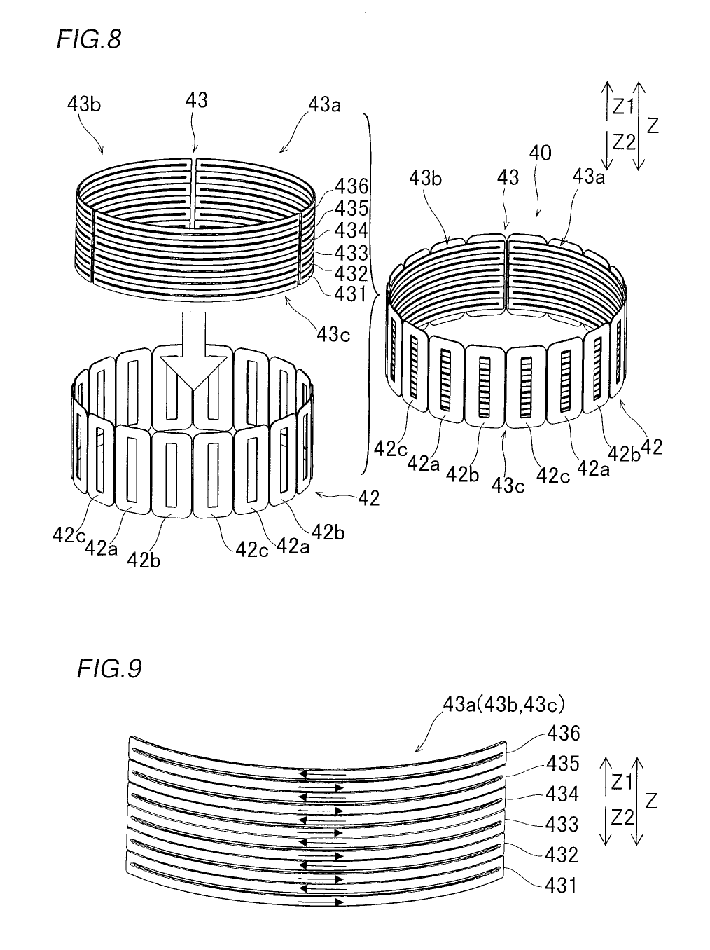

As shown in FIG. 7, the θ drive coil 42 is fixed to the inner periphery of the core 41 and formed of a plurality of coils aligned at equal intervals in a circumferential direction (direction C, see FIG. 7). As shown in FIG. 8, each of the coils has a thin, flattened shape obtained by winding a conducting wire in a substantially rectangular shape. FIG. 8 omits illustration of the core 41. The θ drive coil 42 includes a plurality of θ-U phase coils 42a, a plurality of θ-W phase coils 42b, and a plurality of θ-V phase coils 42c, and these coils are arranged in an order of a θ-U phase coil 42a, a θ-W phase coil 42b, and a θ-V phase coil 42c in the circumferential direction (direction C, see FIG. 7). The total number of the coils (θ-U phase coils 42a, θ-W phase coils 42b, and θ-V phase coils 42c) of the θ drive coil 42 is a multiple of three.

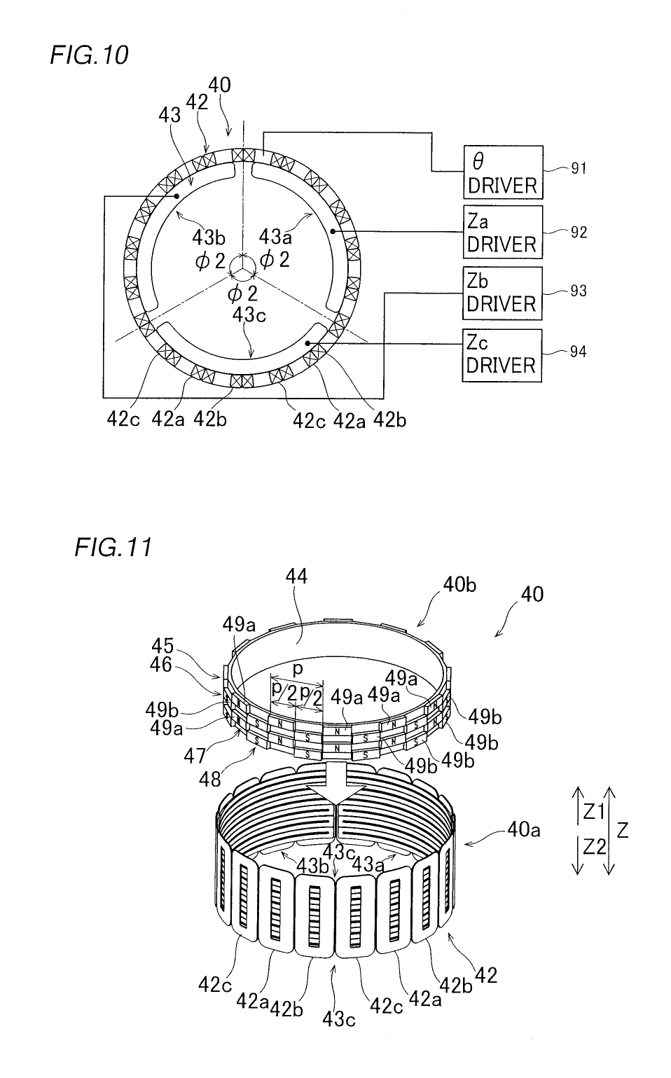

As shown in FIG. 10, the θ-U phase coils 42a, the θ-W phase coils 42b, and the θ-V phase coils 42c of the 0 drive coil 42 each are connected to a 0 driver 91 capable of supplying three-phase (U-W-V phase) current. In FIG. 10, the θ driver 91 is illustrated so as to be connected to the entire θ drive coil 42 for convenience.

According to the first embodiment, the Z drive coil 43 is fixed to the inner periphery of the θ drive coil 42 through an unshown insulating paper and divided into three coil portions 43a, 43b, and 43c capable of being supplied with current independently of each other, as shown in FIG. 8. The three coil portions 43a to 43c each have an arcuate shape, as viewed in the direction Z and are circularly arranged along the circumferential direction (direction C, see FIG. 7) to be electrically separated from each other.

As shown in FIG. 10, the three coil portions 43a to 43c are arranged at equal rotation angular intervals of an angle φ2 (about 120 degrees), as viewed in the direction Z and separated by small clearances from each other. Furthermore, the three coil portions 43a to 43c each have an arcuate shape, as viewed in the direction Z and are formed by stacking a plurality of element coil portions (431 to 436) provided to correspond to three-phase power in the vertical direction (direction Z), as shown in FIGS. 8 and 9.

More specifically, the three coil portions 43a to 43c each are formed of six coils obtained by stacking a U-phase element coil portion 431, a W-phase element coil portion 432, a V-phase element coil portion 433, a U-phase element coil portion 434, a W-phase element coil portion 435, and a V-phase element coil portion 436 in this order from a lower portion to an upper portion, as shown in FIG. 9. These element coil portions (431 to 436) have a flattened, annular shape in the vertical direction (direction Z). Due to this structure, the Z drive coil 43 including the three coils portions 43a to 43c is formed to be generally cylinder-shaped. The U-phase element coil portion 431, the W-phase element coil portion 432, the V-phase element coil portion 433, the U-phase element coil portion 434, the W-phase element coil portion 435, and the V-phase element coil portion 436 are examples of the “element coil portions”.

As shown in FIG. 10, the three coil portions 43a to 43c are connected to a Za driver 92, a Zb driver 93, and a Zc driver 94 each capable of individually supplying three-phase (U-W-V phase) current, respectively thereby being driven individually. These Za driver 92, Zb driver 93, and Zc driver 94 are configured to supply U-phase, W-phase, and V-phase current to the corresponding U-phase element coil portions 431 and 434, W-phase element coil portions 432 and 435, and V-phase element coil portions 433 and 436, respectively. The Za driver 92, the Zb driver 93, and the Zc driver 94 are examples of the “current supply control portions”.

As shown in FIG. 11, the movable element 40b includes a cylindrical yoke 44 and a first magnet array 45, a second magnet array 46, a third magnet array 47, and a fourth magnet array 48 each made of a plurality of permanent magnets. The cylindrical yoke 44 is fixed by fitting the inner periphery thereof into the outer periphery of the holding portion 31a (see FIG. 2) of the rotary table 31. The first magnet array 45 to fourth magnet array 48 each are provided on the outer periphery of the cylindrical yoke 44 and are so arranged in vertical four rows that the permanent magnets (49a or 49b) are aligned in the circumferential direction. As shown in FIG. 6, the first magnet array 45 to fourth magnet array 48 arranged in vertical four rows are arranged at prescribed height positions to be opposed to the stator 40a (0 drive coil 42 and Z drive coil 43) in the radial direction. The first magnet array 45 and the third magnet array 47 are examples of the “first magnet array”, and the second magnet array 46 and the fourth magnet array 48 are examples of the “second magnet array”.

As shown in FIG. 11, the first magnet array 45 is arranged on an upper portion of the yoke 44 and located in the uppermost row of the four magnet arrays. The first magnet array 45 is made of the plurality of permanent magnets 49a aligned at prescribed intervals (pitches p) along the circumferential direction throughout the entire circumference of the annular yoke 44. These permanent magnets 49a each have a substantially rectangular shape that is horizontally long (long in the circumferential direction), as viewed in the radial direction and are so magnetized that the outer surfaces thereof opposed to the stator 40a become north poles. The permanent magnets 49a and the north poles are examples of the “first permanent magnets” and the “first polarity”, respectively.

The second magnet array 46 is located in the second uppermost row of the four magnet arrays. The second magnet array 46 is made of the plurality of permanent magnets 49b aligned at the prescribed intervals (pitches p) along the circumferential direction throughout the entire circumference of the annular yoke 44. These permanent magnets 49b each have a substantially rectangular shape, as viewed in the radial direction, and contrary to the permanent magnets 49a, the permanent magnets 49b are so magnetized that the outer surfaces thereof opposed to the stator 40a become south poles. The permanent magnets 49a of the first magnet array 45 deviate by half pitches (p/2) in the circumferential direction from the permanent magnets 49b of the second magnet array 46. Therefore, as shown in FIG. 7, the permanent magnets 49a of the first magnet array 45 and the permanent magnets 49b of the second magnet array 46 are arranged to appear alternately, as viewed in the direction Z. The permanent magnets 49b and the south poles are examples of the “second permanent magnets” and the “second polarity”, respectively.

As shown in FIG. 11, the third magnet array 47 is located in the third uppermost row of the four magnet arrays. The third magnet array 47 is configured similarly to the first magnet array 45. In other words, the permanent magnets 49a so magnetized that the outer surfaces thereof opposed to the stator 40a become north poles are aligned at the same intervals (pitches p) in the same positions as the first magnet array 45, as viewed in the direction Z.

The fourth magnet array 48 is arranged on a lower portion of the yoke 44 and located in the lowermost (fourth) row of the four magnet arrays. The fourth magnet array 48 is configured similarly to the second magnet array 46. In other words, the permanent magnets 49b so magnetized that the outer surfaces thereof opposed to the stator 40a become south poles are aligned at the same intervals (pitches p) in the same positions as the second magnet array 46, as viewed in the direction Z.

Thus, in the first magnet array 45 and the third magnet array 47, the permanent magnets 49a so magnetized that the outer surfaces thereof become north poles are aligned at the equal pitches p, and in the second magnet array 46 and the fourth magnet array 48, the permanent magnets 49b so magnetized that the outer surfaces thereof become south poles are aligned at the equal pitches p in positions deviating by the half pitches (p/2) from the permanent magnets 49a of the first magnet array 45 (third magnet array 47). Due to this structure, as shown in FIGS. 6 and 7, the lines of magnetic force discharged from the permanent magnets 49a (north poles) of the first magnet array 45 and the third magnet array 47 form such inclined loops that the lines of magnetic force pass through the Z drive coil 43 (coil portion 43a, 43b, or 43c) of the opposed stator 40a and the θ drive coil 42 (θ-U phase coils 42a, θ-W phase coils 42b, or θ-V phase coils 42c) to reach the permanent magnets 49b (south poles) of the second magnet array 46 and the fourth magnet array 48 through the core 41, and then return to the permanent magnets 49a of the first magnet array 45 and the third magnet array 47 deviating by the half pitches (p/2) through the yoke 44 from the permanent magnets 49b of the second magnet array 46 and the fourth magnet array 48. Therefore, the lines of magnetic force formed by the first magnet array 45 to fourth magnet array 48 intersect (are interlinked) with the Z drive coil 43 extending in the horizontal circumferential direction (direction θz) and also intersect (are interlinked) with the θ drive coil 42 extending in the vertical direction Z.

Thus, current is supplied from the θ driver 91 to the θ drive coil 42 (θ-U phase coils 42a, θ-W phase coils 42b, or θ-V phase coils 42c) of the stator 40a, whereby electromagnetic force (thrust) can be generated between the θ drive coil 42 and the movable element 40b (first magnet array 45 to fourth magnet array 48), and hence the movable element 40b can be moved in the circumferential direction (direction C). Furthermore, current is supplied from the Za driver 92, the Zb driver 93, and the Zc driver 94 to the Z drive coil 43 (coil portions 43a, 43b, and 43c) of the stator 40a, whereby electromagnetic force (thrust) can be generated between each of the coil portions 43a to 43c and the movable element 40b (first magnet array 45 to fourth magnet array 48), and hence the movable element 40b can be moved in the vertical direction (direction Z). According to the first embodiment, current is supplied from the Za driver 92, the Zb driver 93, and the Zc driver 94 that are independent of each other to the coil portions 43a, 43b, and 43c, whereby the coil portions 43a, 43b, and 43c can be driven independently.

As shown in FIG. 5, the three up/down movement detecting portions 50 are provided at equal rotation angular intervals of an angle φ3 (about 120 degrees) on the periphery of the elevating table 32 in plan view and arranged in the region between the outer cylindrical portion 32c of the elevating table 32 and the holding portion 31a of the rotary table 31. The three up/down movement detecting portions 50 are arranged in rotation angular positions corresponding to substantially central positions A, B, and C of the three arcuate coil portions 43a to 43c of the Z drive coil 43 in plan view, respectively. Therefore, the three up/down movement detecting portions 50 have a function of detecting the position and speed of the stage 30 (elevating table 32) in the vertical direction (direction Z) at the positions (rotation angular positions) A, B, and C corresponding to the three coil portions 43a to 43c, respectively.

As shown in FIG. 3, the three up/down movement detecting portions 50 include linear scales 51 provided to extend in the vertical direction (direction Z) on the outer periphery of the outer cylindrical portion 32c of the elevating table 32 and detection heads 52 fixedly provided on the base portion 10 through brackets 53. As the detection heads 52, principle detection heads such as optical detection heads or magnetic detection heads can be employed. Thus, the three up/down movement detecting portions 50 are configured to be capable of detecting the position and speed of the stage 30 in the vertical direction (direction Z) by detecting the relative positions of the linear scales 51 with respect to the detection heads 52 when the stage 30 (elevating table 32) moves in the direction Z. As shown in FIG. 4, detection signals from the three up/down movement detecting portions (detection heads 52) 50 arranged in the positions A, B, and C, respectively are input to the Za driver 92, the Zb driver 93, and the Zc driver 94 driving the corresponding coil portions 43a to 43c, respectively. The Za driver 92, the Zb driver 93, and the Zc driver 94 are configured to control current supplied to the corresponding coil portions 43a, 43b, and 43c on the basis of detection positions at the positions A, B, and C, respectively. Thus, the stage 30 can be positioned at a prescribed position in the direction Z by equally driving the stage 30 in the vertical direction (direction Z) on the basis of the detection positions at the positions A, B, and C, and the inclination (positions in the directions θx and θy) of the stage 30 with respect to the horizontal plane can be adjusted by varying the amounts of drive (amounts of displacement) in the vertical direction (direction Z) of the stage 30 at the positions A, B, and C from each other.

As shown in FIG. 2, the rotation detecting portion 60 includes an encoder disk 61 and a detection head 62 and has a function of detecting the rotation angular position of the rotary table 31 in the direction θz. The encoder disk 61 has an annular plate-like shape and is mounted on a flange portion 31e provided on the outer surface of the mounting portion 31b. As the detection head 62, a principle detection head such as an optical detection head or magnetic detection head can be employed. Thus, the encoder disk 61 is configured to rotate in the direction θz integrally with the rotary table 31. The detection head 62 is mounted on an upper portion of the outer cylindrical portion 32c of the elevating table 32. When the stage 30 rotates in the direction θz, the rotary table 31 rotates with respect to the elevating table 32 so that the rotation angular position and rotation speed of the stage 30 in the direction θz can be detected by detecting the relative position of the encoder disk 61 with respect to the detection head 62. As shown in FIG. 4, a detection signal from the rotation detecting portion 60 is input to the θ driver 91 driving the θ drive coil 42. Thus, the stage 30 can be positioned at a prescribed position in the direction θz by rotationally driving the stage 30 (rotary table 31) in the direction θz on the basis of the position (rotation angular position) detected by the rotation detecting portion 60.

As shown in FIG. 5, the three weight compensation portions 70 are provided on the periphery of the elevating table 32 at equal rotation angular intervals of an angle φ (about 120 degrees) in plan view and arranged in the region between the outer cylindrical portion 32c of the elevating table 32 and the holding portion 31a of the rotary table 31. Thus, in the region between the outer cylindrical portion 32c of the elevating table 32 and the holding portion 31a of the rotary table 31, the three second guide portions 35, the three up/down movement detecting portions 50, and the three weight compensation portions 70 are arranged in rotation angular positions deviating from each other at the equal rotation angular intervals of about 120 degrees (angles φ1, φ3, and φ4).

The weight compensation portions 70 are provided to support the weights of the stage 30, the bearing 33, the spline 34a of the first guide portion 34, the slide rails 35a of the second guide portions 35, etc. or the weight of the substrate holding mechanism (not shown) mounted on the upper surface of the rotary table 31 etc. Thus, the actuator 40 only needs to generate thrust necessary to drive the stage 30 and is not required to support the weight of the stage 30 etc.

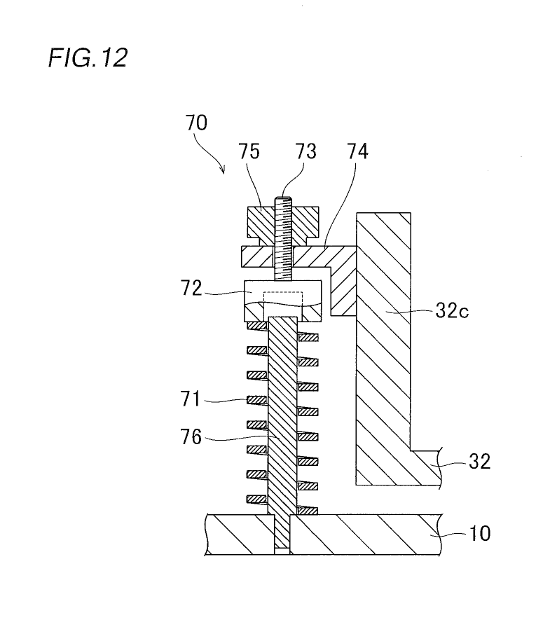

As shown in FIG. 12, the three weight compensation portions 70 include compensation springs 71 having lower ends coming into contact with the upper surface of the base portion 10, pressing members 72 coming into contact with the upper surface sides of the compensation springs 71, spring seats 74 to fix the pressing members 72 to the outer cylindrical portion 32c of the elevating table 32 by engaging with adjustment screws 73 of the pressing members 72, nuts 75 to lock the adjustment screws 73, and spring support rods 76 arranged inside the compensation springs 71. The spring support rods 76 are fixed to stand upward from the base portion 10 and configured to prevent the compensation springs 71 from buckling.

The weight of the stage 30 is transmitted to the compensation springs 71 through the spring seats 74 fixedly provided on the outer cylindrical portion 32c of the elevating table 32 and the pressing members 72 having the adjustment screws 73 engaging with the spring seats 74. The compensation springs 71 compressed between the base portion 10 and the pressing members 72 are configured to support the stage 30 in a state movable in the vertical direction (direction Z) at a prescribed height position in a natural state where the drive force of the actuator 40 does not act by repulsive force against compression. This height position of the stage 30 can be adjusted by varying the feed rates of the adjustment screws 73 (positions of the pressing members 72 with respect to the spring seats 74). After adjustment of the height position of the stage 30, the nuts 75 engaging with the adjustment screws 73 are tightened, whereby the adjustment screws 73 are prevented from loosening.

As shown in FIG. 2, the exhaust mechanism 80 is provided to maintain pressure inside the θZ stage unit 110 at negative pressure by exhausting air inside the θZ stage unit 110 from an exhaust hole 81. The exhaust hole 81 is provided in a lower end portion of the frame 20 and so configured that the inside of the frame 20 (inside of the θZ stage unit 110) communicates with the outside of the frame 20 therethrough. The outside of the exhaust hole 81 is connected with an unshown exhauster through a joint 82. As described above, an internal space substantially closed except a small gap between the rotary table 31 and the cover 21 is formed in the θZ stage unit 110 by the base portion 10 on the lower side, the frame 20 on the lateral side, and the rotary table 31 and the cover 21 on the upper side. Therefore, the air inside the substantially closed θZ stage unit 110 is exhausted by the exhaust mechanism 80, whereby fine particles generated from the bearing 33 or the second guide portions 35 following operation of the θZ stage unit 110 can be prevented from flowing out to the outside. Thus, adhesion of the fine particles to the substrate such as a semiconductor wafer mounted on the stage 30 can be suppressed.

Next, operations of the θZ stage unit 110 of the XYθZ stage 100 according to the first embodiment are described with reference to FIGS. 1 to 7 and 10 to 12.

First, current is supplied to the Z drive coil 43 of the stator 40a of the actuator 40, whereby thrust in the upward direction (along arrow Z1) or the downward direction (along arrow Z2) is generated in the movable element 40b in a case where the stage 30 is driven in the vertical direction, as shown in FIG. 6. More specifically, the Za driver 92, the Zb driver 93, and the Zc driver 94 supply three-phase (U-W-V phase) current of appropriate phases to the respective coil portions (coil portions 43a, 43b, and 43c) of the Z drive coil 43, as shown in FIG. 10. Thus, electromagnetic force (thrust) in the upward direction (along arrow Z1) or the downward direction (along arrow Z2) can be generated between the respective coil portions (coil portions 43a, 43b, and 43c) of the Z drive coil 43 and the movable element 40b due to the direction of current and the direction of a magnetic field. At this time, thrust larger than the restoring force of the compensation springs 71 (see FIG. 12) of the weight compensation portions 70 is generated, whereby the movable element 40b (rotary table 31) starts to move in the upward direction (along arrow Z1) or the downward direction (along arrow Z2).

When the stage 30 moves in the vertical direction, the rotary table 31 and the elevating table 32 integrally move. Therefore, the entire stage 30 moves in the upward direction (along arrow Z1) or the downward direction (along arrow Z2) while the elevating table 32 is guided in the vertical direction (direction Z) by the first guide portion 34 and the three second guide portions 35 on the outer periphery, as shown in FIGS. 3 and 5. At this time, displacement of the elevating table 32 in the direction Z is detected by the three up/down movement detecting portions 50 (detection heads 52) and input to the corresponding Za driver 92, Zb driver 93, and Zc driver 94, as shown in FIG. 4. The position of the movable element 40b can be obtained on the basis of the detected position of the elevating table 32 in the direction Z.

Thus, the Za driver 92, the Zb driver 93, and the Zc driver 94 control phases of three-phase current flowing to the U-phase element coil portions 431 and 434, the W-phase element coil portions 432 and 435, and the V-phase element coil portions 433 and 436 of the respective coil portions (coil portions 43a, 43b, and 43c) in response to the acquired position of the movable element 40b in the direction Z, as shown in FIGS. 6 and 10, whereby the stage 30 can be positioned at an intended height position.

In a case where the inclination (positions in the directions θx and θy) of the stage 30 is adjusted, the Za driver 92, the Zb driver 93, and the Zc driver 94 apply three-phase (U-W-V phase) current of different phases to the coil portions 43a, 43b, and 43c of the Z drive coil 43, respectively, whereby the amounts of displacement of the movable element 40b in the direction Z corresponding to the coil portions 43a, 43b, and 43c are controlled individually. In this case, the amounts of displacement in the direction Z at the positions A, B, and C corresponding to the coil portions 43a, 43b, and 43c are detected by the respective three up/down movement detecting portions 50 (detection heads 52), as shown in FIG. 5. Phases of the three-phase current supplied to the coil portions 43a, 43b, and 43c are controlled appropriately on the basis of the amounts of displacement detected at the positions A, B, and C, whereby the respective height positions of the stage 30 at the positions A, B, and C can be controlled individually, and hence the inclination (positions in the directions θx and θy) of the stage 30 can be adjusted. Consequently, the inclination (movement in the directions θx and θy) of the stage 30 with respect to the horizontal plane can be finely adjusted in a small range in which the stage 30 can move in view of small backlashes present between the first guide portion 34 and the three second guide portions 35 and the elevating table 32 and the rigidity of the first guide portion 34 and the three second guide portions 35. According to the first embodiment, the respective height positions (height positions of three points located at rotation angular intervals of 120 degrees as viewed in the direction Z) of the stage 30 at the positions A, B, and C are controlled, whereby the stage 30 can be driven (finely adjusted) to be inclined about an arbitrary axis in the horizontal plane.

In a case where the stage 30 is driven in the direction θz (rotation direction), as shown in FIG. 7, current is supplied to the θ drive coil 42 of the stator 40a of the actuator 40, whereby thrust in the direction θz is generated in the movable element 40b. More specifically, the θ driver 91 (see FIG. 10) supplies three-phase current of appropriate phases to the plurality of θ-U phase coils 42a, θ-W phase coils 42b, and θ-V phase coils 42c of the θ drive coil 42, whereby electromagnetic force (thrust) in the direction θz can be generated between the θ drive coil 42 and the movable element 40b due to the direction of current and the direction of a magnetic field. In this case, the rotary table 31 of the stage 30 is supported by the elevating table 32 through the bearing 33 so as to be rotatable in the direction θz, and hence only the rotary table 31 moves in the direction θz independently.

At this time, the displacement of the rotary table 31 in the direction θz is detected by the rotation detecting portion 60 (detection head 62) and input to the corresponding θ driver 91, as shown in FIGS. 2 and 4. The position of the movable element 40b can be obtained on the basis of the detected position of the rotary table 31 in the direction θz. Thus, the θ driver 91 controls phases of three-phase current supplied to the θ-U phase coils 42a, the θ-W phase coils 42b, and the θ-V phase coils 42c of the θ drive coil 42 in response to the acquired position of the movable element 40b in the direction θz, whereby the stage 30 can be positioned at an intended rotation angular position (position in the direction θz).

As shown in FIG. 1, the θZ stage unit 110 is moved in the direction X and the direction Y to be arranged at a prescribed position in the direction X-Y by the XY stage unit 120 of the XYθ stage 100. In this manner, the stage 30 is positioned in the directions X, Y, Z, and θz, and the inclinations thereof in the direction θx and the direction θy are finely adjusted.

According to the first embodiment, as hereinabove described, the Z drive coil 43 of the single actuator 40 is divided into the three coil portions 43a, 43b, and 43c capable of being supplied with current independently of each other, and the three coil portions 43a, 43b, and 43c are so arranged that the stage 30 can be driven in the direction Z, the direction θx, and the direction θy, whereby the stage 30 can be driven in the direction Z, the direction θx, and the direction θy in response to current independently supplied to the three coil portions 43a, 43b, and 43c. Thus, even if the substrate placed on the stage 30 through the substrate holding mechanism is slightly inclined with respect to the horizontal plane, the actuator 40 can adjust the inclination (positions in the directions θx and θy) of the stage 30 (substrate) with respect to the horizontal plane. Furthermore, the single actuator 40 can drive the stage 30 in the direction θx and the direction θy in addition to the direction Z, and hence increase in the size of the apparatus can be suppressed even if a mechanism performing driving in the direction θx and the direction θy is added. Therefore, in the θZ stage unit 110 according to the first embodiment, the inclination (positions in the directions θx and θy) of the stage 30 with respect to the horizontal plane can be adjusted while increase in the size of the apparatus is suppressed.

According to the first embodiment, as hereinabove described, the three Za driver 92, the Zb driver 93, and the Zc driver 94 provided to correspond to the three coil portions 43a, 43b, and 43c constituting the Z drive coil 43, respectively and supplying current individually to the three coil portions 43a, 43b, and 43c is provided, whereby the Za driver 92, the Zb driver 93, and the Zc driver 94 can supply current independently of each other to the corresponding coil portions 43a, 43b, and 43c. Thus, driving in the direction θx and the direction θy in addition to the direction Z can be easily performed.

According to the first embodiment, as hereinabove described, the three up/down movement detecting portions 50 corresponding to the coil portions 43a, 43b, and 43c are provided, and the XYθZ stage 100 is configured to control current supplied to the corresponding coil portions 43a, 43b, and 43c on the basis of results of position detection (results of detection of positions in the direction Z at the positions A, B, and C) of the three up/down movement detecting portions 50, whereby the inclination of the stage 30 with respect to the horizontal plane can be detected on the basis of results of detection of the positions in direction Z of respective portions corresponding to the three coil portions 43a, 43b, and 43c (results of detection of positions in the direction Z at the positions A, B, and C). Thus, the inclination (positions in the directions θx and θy) of the stage 30 with respect to the horizontal plane can be accurately adjusted on the basis of the results of detection of positions in the direction Z at the positions A, B, and C.

According to the first embodiment, as hereinabove described, the three coil portions 43a, 43b, and 43c constituting the Z drive coil 43 each have an arcuate shape, as viewed in the direction Z and are circularly arranged along the circumferential direction to be electrically separated from each other, whereby the coil portions 43a, 43b, and 43c circularly arranged can cause drive force to act on the stage 30 throughout the substantially entire circumference of the coil portions 43a, 43b, and 43c (substantially entire circumference of the circle) when all of the coil portions 43a, 43b, and 43c are driven. Thus, the entire stage 30 can be accurately moved in the direction Z.

According to the first embodiment, as hereinabove described, the three coil portions 43a, 43b, and 43c each have an arcuate shape, as viewed in the direction Z and are formed by stacking the six element coil portions (U-phase element coil portion 431, W-phase element coil portion 432, V-phase element coil portion 433, U-phase element coil portion 434, W-phase element coil portion 435, and V-phase element coil portion 436) provided to correspond to three-phase power in the direction Z, whereby the coil portions 43a, 43b, and 43c can easily control driving of the movable element 40b in the direction Z by controlling phases of current supplied to the element coil portions (U-phase element coil portion 431, W-phase element coil portion 432, V-phase element coil portion 433, U-phase element coil portion 434, W-phase element coil portion 435, and V-phase element coil portion 436) stacked in the direction Z.

According to the first embodiment, as hereinabove described, the three coil portions 43a, 43b, and 43c constituting the Z drive coil 43 are arranged at the equal rotation angular intervals of about 120 degrees, whereby drive force (electromagnetic force) acting on the stage 30 is not varied depending on the rotation angular position in the direction θz when these coil portions 43a, 43b, and 43c are driven individually.

According to the first embodiment, as hereinabove described, in addition to the Z drive coil 43, the θ drive coil 42 to rotate the stage 30 in the direction θz is further provided in the stator 40a of the actuator 40, the Z drive coil 43 and the θ drive coil 42 are integrally provided and annularly arranged, and the actuator 40 is configured to be capable of driving the stage 30 in the direction Z, the direction θx, the direction θy, and the direction θz. According to this structure, the stage 30 can be driven not only in the direction Z, the direction θx, and the direction θy but also in the direction θz by the single actuator 40. Thus, the θZ stage unit 110 can be downsized as compared with a case where actuators to drive the stage 30 in various directions (Z, θx, θy, θz) are provided separately.

According to the first embodiment, as hereinabove described, the Z drive coil 43 and the θ drive coil 42 are integrally bonded to each other through the insulating paper, whereby the Z drive coil 43 and the θ drive coil 42 can be integrated while being electrically separated from each other. Thus, the stator 40a of the actuator 40 can be downsized.

According to the first embodiment, as hereinabove described, the first magnet array 45 and the third magnet array 47 including the plurality of permanent magnets 49a arranged at the same pitches p along the annular circumferential direction and so magnetized that the surfaces of portions opposed to the Z drive coil 43 and the θ drive coil 42 become north poles and the second magnet array 46 and the fourth magnet array 48 including the plurality of permanent magnets 49b adjacent to the first magnet array 45 and the third magnet array 47 in the direction Z, arranged at the same pitches p along the annular circumferential direction, and so magnetized that the surfaces of portions opposed to the Z drive coil 43 and the θ drive coil 42 become south poles are provided in the movable element 40b of the actuator 40, while the permanent magnets 49a and the permanent magnets 49b are arranged to appear alternately along the circumferential direction, as viewed in the direction Z. According to this structure, the lines of magnetic force formed by the first and third magnet arrays 45 and 47 and the second and fourth magnet arrays 46 and 48 can be interlinked (intersect) with the coil (Z drive coil 43) in the horizontal direction to generate electromagnetic force in the direction Z while the lines of magnetic force formed by the first and third magnet arrays 45 and 47 and the second and fourth magnet arrays 46 and 48 can be interlinked (intersect) with the coil (0 drive coil 42) in the direction Z to generate electromagnetic force in the direction θz. Thus, both the Z drive coil 43 and the 0 drive coil 42 can share the permanent magnets (49a and 49b) on the side of the movable element 40b, and hence driving in the direction Z and the direction θz can be attained with the common permanent magnets (49a and 49b) while the movable element 40b of the actuator 40 is downsized.

According to the first embodiment, as hereinabove described, the actuator 40 is annularly arranged in the vicinity of the outer periphery of the stage 30, whereby the size of the actuator 40 can be maximally increased in the range of the size of the stage 30 having the diameter D1. Thus, the drive force (electromagnetic force) of the actuator 40 can be increased without increasing the overall size of the θZ stage unit 110.

According to the first embodiment, as hereinabove described, the Z drive coil 43 is constituted by the three coil portions 43a, 43b, and 43c capable of being supplied with current independently of each other, whereby the Z drive coil 43 can be constituted by a minimum number of (three) coils necessary for driving in the direction Z, the direction θx, and the direction θy so that the θZ stage unit 110 can be downsized.

According to the first embodiment, as hereinabove described, the X-direction drive portion 121 driving the θZ stage unit 110 in the direction X in the horizontal plane and the Y-direction drive portion 122 driving the θZ stage unit 110 in the direction Y in the horizontal direction are provided, whereby the stage 30 can be moved in the direction X and the direction Y in the horizontal plane in addition to the direction Z, the direction θz, the direction θx, and the direction θy. Thus, the XYθZ stage 100 capable of positioning the stage 30 accurately by adjusting the inclination (positions in the directions θx and θy) of the stage 30 with respect to the horizontal plane can be provided.

### Second Embodiment

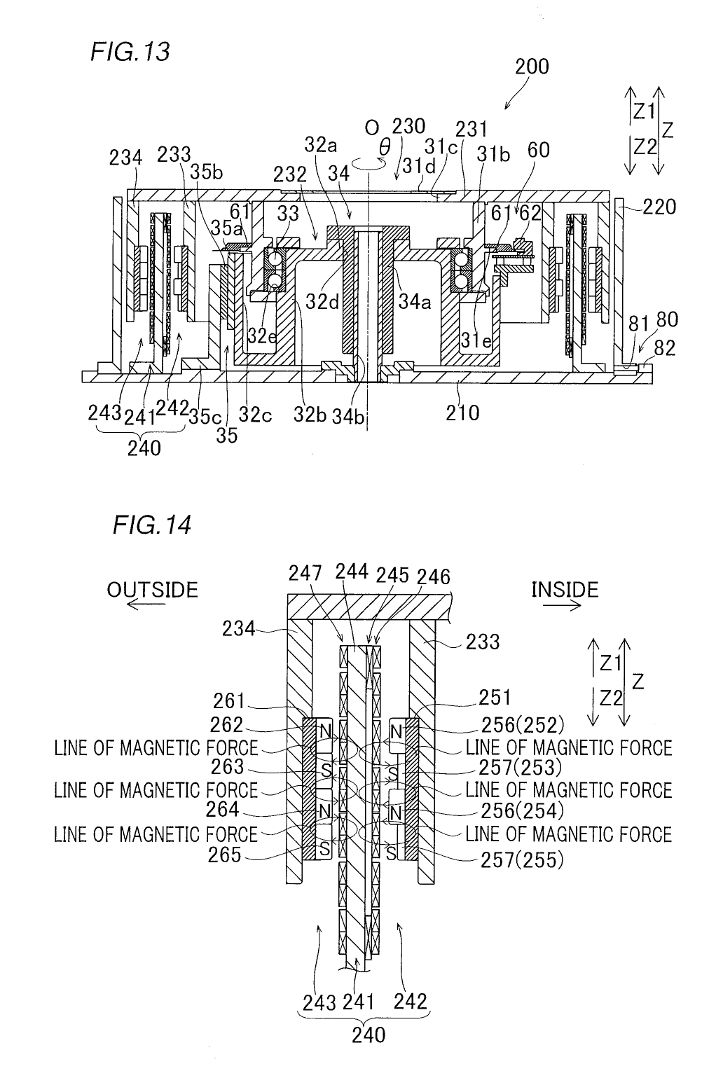

Next, a second embodiment is described with reference to FIGS. 13 to 16. In this second embodiment, an actuator has two movable elements, dissimilarly to the aforementioned first embodiment in which the aforementioned actuator has the single movable element.

As shown in FIG. 13, a θZ stage unit 200 according to the second embodiment includes a base portion 210, a frame 220, a stage 230 having an upper surface on which a substrate holding mechanism (not shown) or the like to hold a substrate such as a semiconductor wafer is placed, and a single actuator 240 driving the stage 230. The frame 220 has a cylindrical shape and is fixedly set on the base portion 210. The frame 220 constitutes the outer surface portion of the θZ stage unit 200.

The stage 230 includes a rotary table 231 constituting the upper surface side of the θZ stage unit 200 and an elevating table 232 supporting the rotary table 231 to be rotatable in a direction θz. The rotary table 231 includes a cylindrical holding portion 233 protruding downward (along arrow Z2) in the outer periphery and a cylindrical holding portion 234 protruding downward in the outermost periphery outside the holding portion 233.

The actuator 240 is annularly arranged throughout the entire circumference of the θZ stage unit 200 in the vicinity of the outer periphery of the stage 230 (inside the frame 220). The actuator 240 includes a stator 241 provided on a surface of the base portion 210, a movable element 242 fixedly provided on the outer periphery of the holding portion 233 of the rotary table 231, and a movable element 243 fixedly provided on the inner periphery of the holding portion 234 of the rotary table 231. The stator 241 and the movable element 242 (movable element 243) of the actuator 240 are arranged to be opposed to each other at a prescribed interval in a radial direction (horizontal direction).

As shown in FIG. 14, the stator 241 includes a core 244 and a θ drive coil 245 provided to be opposed to the holding portion 233 for rotationally driving the stage 230 (rotary table 231) in the direction θz. The stator 241 further includes a Z drive coil 246 provided to be opposed to the holding portion 233 for driving the stage 230 in a direction Z and a Z drive coil 247 provided to be opposed to the holding portion 234 for driving the stage 230 in the direction Z. The core 244, the θ drive coil 245, the Z drive coil 246, and the Z drive coil 247 are integrally bonded to each other through unshown insulating papers. The θ drive coil 245 is an example of the “θz-direction drive coil”. The Z drive coil 246 is an example of the “Z-direction drive coil” or the “inner Z-direction drive coil”. The Z drive coil 247 is an example of the “Z-direction drive coil” or the “outer Z-direction drive coil”.

The core 244 is formed by stacking electromagnetic steel sheets and has a cylindrical shape. The core 244 is fixed on the surface of the base portion 210.

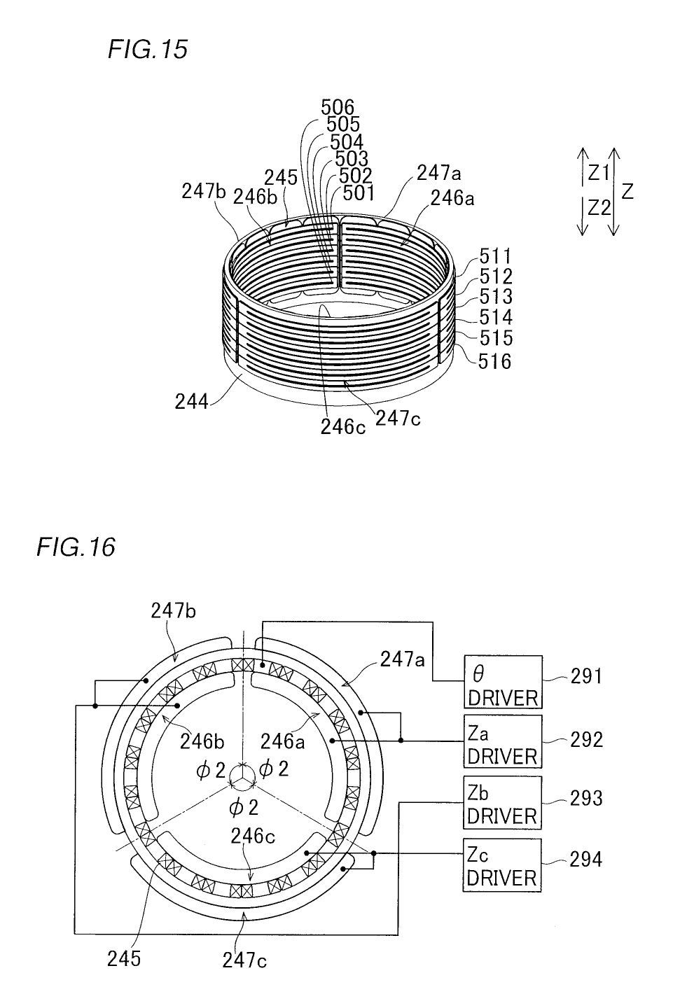

The detailed structure of the θ drive coil 245 is similar to that of the θ drive coil 42 according to the aforementioned first embodiment shown in FIG. 7. As shown in FIGS. 15 and 16, the Z drive coil 246 is fixed to the inner periphery of the θ drive coil 245 through an unshown insulating paper and divided into three coil portions 246a, 246b, and 246c capable of being supplied with current independently of each other. The three coil portions 246a, 246b, and 246c each have an arcuate shape, as viewed in the direction Z and are circularly arranged along a circumferential direction to be electrically separated from each other. The Z drive coil 247 is fixed to the outer periphery of the core 244 through an unshown insulating paper and divided into three coil portions 247a, 247b, and 247c capable of being supplied with current independently of each other. The three coil portions 247a, 247b, and 247c each have an arcuate shape, as viewed in the direction Z and are circularly arranged along the circumferential direction to be electrically separated from each other.

As shown in FIG. 16, the three coil portions 246a, 246b, and 246c are arranged at equal rotation angular intervals of an angle φ2 (about 120 degrees), as viewed in the direction Z and separated by small clearances from each other. Similarly, the three coil portions 247a, 247b, and 247c are arranged at the equal rotation angular intervals of an angle φ2 (about 120 degrees), as viewed in the direction Z and separated by small clearances from each other. Furthermore, the three coil portions 246a, 246b, and 246c (coil portions 247a, 247b, and 247c) each have an arcuate shape, as viewed in the direction Z and are formed by stacking a plurality of element coil portions 501, 502, 503, 504, 505, and 506 (511, 512, 513, 514, 515, and 516) provided to correspond to three-phase power in the vertical direction (direction Z), as shown in FIG. 15.

As shown in FIG. 16, the θ drive coil 245 is connected to a θ driver 291 capable of supplying three-phase (U-W-V phase) current. The three coil portions 246a, 246b, and 246c of the Z drive coil 246 are connected to a Za driver 292, a Zb driver 293, and a Zc driver 294 each capable of individually supplying three-phase (U-W-V phase) current, respectively thereby being driven individually. Similarly, the three coil portions 247a, 247b, and 247c of the Z drive coil 247 are connected to the Za driver 292, the Zb driver 293, and the Zc driver 294 each capable of individually supplying three-phase (U-W-V phase) current, respectively thereby being driven individually. The Za driver 292, the Zb driver 293, and the Zc driver 294 are examples of the “current supply control portions”.

The structure of the movable element 242 is similar to that of the movable element 40b according to the aforementioned first embodiment shown in FIG. 11. In other words, the inner movable element 242 includes a cylindrical yoke 251 and a first magnet array 252, a second magnet array 253, a third magnet array 254, and a fourth magnet array 255 each made of a plurality of permanent magnets, as shown in FIG. 14. The cylindrical yoke 251 is fixed by fitting the inner periphery thereof into the outer periphery of the holding portion 233 of the rotary table 231. The first magnet array 252 to fourth magnet array 255 each are provided on the outer periphery of the cylindrical yoke 251 and are so arranged in vertical four rows that permanent magnets 256 (or permanent magnets 257) are aligned in the circumferential direction. Furthermore, the first magnet array 252 to fourth magnet array 255 arranged in vertical four rows are arranged at prescribed height positions to be opposed to the stator 241 (θ drive coil 245 and Z drive coil 246) in the radial direction. The first magnet array 252 and the third magnet array 254 are examples of the “first magnet array”, and the second magnet array 253 and the fourth magnet array 255 are examples of the “second magnet array”. The permanent magnets 256 are examples of the “inner permanent magnet” or the “first permanent magnets”. The permanent magnets 257 are examples of the “inner permanent magnet” or the “second permanent magnets”.

The first magnet array 252 (third magnet array 254) is made of a plurality of permanent magnets 256 aligned at prescribed intervals (pitches p) along the circumferential direction throughout the entire circumference of the annular yoke 251, similarly to the aforementioned first embodiment shown in FIG. 11. These permanent magnets 256 are so magnetized that the outer surfaces thereof opposed to the stator 241 become north poles. The second magnet array 253 (fourth magnet array 255) is made of a plurality of permanent magnets 257 aligned at prescribed intervals (pitches p) along the circumferential direction throughout the entire circumference of the annular yoke 251, similarly to the aforementioned first embodiment shown in FIG. 11. These permanent magnets 257 are so magnetized that the outer surfaces thereof opposed to the stator 241 become south poles.

The outer movable element 243 includes a cylindrical yoke 261 and a permanent magnet 262, a permanent magnet 263, a permanent magnet 264, and a permanent magnet 265 each made of a plurality of substantially annular permanent magnets. The cylindrical yoke 261 is fixed by fitting the outer periphery thereof into the inner periphery of the holding portion 234 of the rotary table 231. The permanent magnet 262 to permanent magnet 265 each are provided on the inner periphery of the cylindrical yoke 261 and are arranged in vertical four rows. Furthermore, the permanent magnet 262 to permanent magnet 265 arranged in vertical four rows are arranged at prescribed height positions to be opposed to the stator 241 (Z drive coil 247) in the radial direction. The permanent magnet 262 and the permanent magnet 264 are so magnetized that the outer surfaces thereof opposed to the stator 241 become north poles. The permanent magnet 263 and the permanent magnet 265 are so magnetized that the outer surfaces thereof opposed to the stator 241 become south poles. The permanent magnet 262 (permanent magnet 264) is an example of the “outer permanent magnet” or the “third permanent magnet”. The permanent magnet 263 (permanent magnet 265) is an example of the “outer permanent magnet” or the “fourth permanent magnet”.

The lines of magnetic force discharged from the permanent magnets 256 (north poles) of the first magnet array 252 and the third magnet array 254 of the movable element 242 pass through the Z drive coil 246 (coil portion 246a, 246b, and 246c) of the opposed stator 241 and the θ drive coil 245 and reach the permanent magnets 257 (south poles) of the second magnet array 253 and the fourth magnet array 255 through the core 244. Therefore, the lines of magnetic force formed by the first magnet array 252 to fourth magnet array 255 intersect (are interlinked) with the Z drive coil 246 extending in the horizontal circumferential direction (direction θz) and also intersect (are interlinked) with the θ drive coil 245 extending in the vertical direction Z.

The lines of magnetic force discharged from the permanent magnet 262 and the permanent magnet 264 (north poles) of the movable element 243 pass through the Z drive coil 247 (coil portion 247a, 247b, and 247c) of the opposed stator 241 and reach the permanent magnet 263 and the permanent magnet 265 (south poles) through the core 244. Therefore, the lines of magnetic force formed by the permanent magnet 262 to permanent magnet 265 intersect (are interlinked) with the Z drive coil 247 extending in the horizontal circumferential direction (direction θz).

Thus, current is supplied from the θ driver 291 to the θ drive coil 245 of the stator 241, whereby electromagnetic force (thrust) can be generated between the θ drive coil 245 and the movable element 242 (first magnet array 252 to fourth magnet array 255), and hence the movable element 242 can be moved in the circumferential direction. Furthermore, current is supplied from the Za driver 292, the Zb driver 293, and the Zc driver 294 to the Z drive coil 246 (coil portions 246a, 246b, and 246c) of the stator 241, whereby electromagnetic force (thrust) can be generated between each of the coil portions 246a, 246b, and 246c and the movable element 242 (first magnet array 252 to fourth magnet array 255), and hence the movable element 242 can be moved in the vertical direction (direction Z). In addition, current is supplied from the Za driver 292, the Zb driver 293, and the Zc driver 294 to the Z drive coil 247 (coil portions 247a, 247b, and 247c) of the stator 241, whereby electromagnetic force (thrust) can be generated between each of the coil portions 247a, 247b, and 247c and the movable element 243 (permanent magnet 262 to permanent magnet 265), and hence the movable element 243 can be moved in the vertical direction (direction Z). Current is supplied from the Za driver 292, the Zb driver 293, and the Zc driver 294 that are independent of each other to the coil portions 246a, 246b, and 246c (coil portions 247a, 247b, and 247c), whereby the coil portions 246a, 246b, and 246c (coil portions 247a, 247b, and 247c) can be driven independently.

According to the second embodiment, as hereinabove described, the θZ stage unit 200 includes the permanent magnets 256 and 257 provided in the movable element 242 and the permanent magnets 262 to 265 provided in the movable element 243 and includes the Z drive coil 246 provided in the stator 241 to be opposed to the permanent magnets 256 and 257 and the Z drive coil 247 provided to be opposed to the permanent magnets 262 to 265. Thus, thrust driving the actuator 240 can be increased by the electromagnetic force (thrust) of the permanent magnets 262 to 265 and the Z drive coil 247 as compared with a case where the actuator 240 is driven by only the electromagnetic force (thrust) of the permanent magnets 256 and 257 and the Z drive coil 246.

According to the second embodiment, as hereinabove described, the permanent magnets 256 arranged along the annular circumferential direction, in which surfaces of portions opposed to the Z drive coil 246 have north polarity and the permanent magnets 257 adjacent to the permanent magnets 256 in the direction Z and arranged along the annular circumferential direction, in which surfaces of portions opposed to the Z drive coil 246 have south polarity are provided, while the permanent magnets 262 and 264 arranged along the annular circumferential direction, in which surfaces of portions opposed to the Z drive coil 247 have north polarity and the permanent magnets 263 and 265 adjacent to the permanent magnets 262 and 264 in the direction Z and arranged along the annular circumferential direction, in which surfaces of portions opposed to the Z drive coil 247 have south polarity are provided. Thus, the lines of magnetic force formed by the permanent magnets 256 and 257 can be interlinked (intersect) with the coil (Z drive coil 246) in the horizontal direction to generate electromagnetic force in the direction Z. Furthermore, the lines of magnetic force formed by the permanent magnets 262 to 265 can be interlinked (intersect) with the coil (Z drive coil 247) in the horizontal direction to generate electromagnetic force in the direction Z.

According to the second embodiment, as hereinabove described, the permanent magnet 262 (263, 264, 265) is substantially annularly formed. Thus, the intensity of a magnetic field generated by the permanent magnet 262 (263, 264, 265) can be increased as compared with a case where the permanent magnet 262 (263, 264, 265) is constituted by a plurality of permanent magnets arranged at substantially the same pitch intervals along the annular circumferential direction.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are included.

For example, while the example of applying the stage apparatus and the θZ drive apparatus to the XYθZ stage to position an exposure apparatus, an inspection apparatus, or the like for a semiconductor wafer and the θZ stage unit employed therein, respectively has been shown in the aforementioned first embodiment, the present invention is not restricted to this. The θZ drive apparatus is also applicable to a θZ stage unit of an apparatus other than the stage to position an exposure apparatus, an inspection apparatus, or the like so far as the same is an apparatus driving a stage in the vertical direction (direction Z) and the rotation direction (direction θz). Furthermore, the θZ drive apparatus may be employed independently. In addition, the stage apparatus may be applied to an XYθZ stage other than the XYθZ stage to position an exposure apparatus, an inspection apparatus, or the like.

While the example of configuring the XYθZ stage 100 to be capable of driving the stage 30 in the direction Z, the directions θx and θy that are inclinations with respect to the horizontal plane, and the direction θz by the single actuator 40 has been shown in the aforementioned first embodiment, the present invention is not restricted to this. The actuator 40 may be configured to drive the stage only in the direction Z and the directions θx and θy. An actuator to drive the stage in the direction θz may be provided separately.

While the example of integrally bonding the θ drive coil 42 and the Z drive coil 43 of the single actuator 40 to each other through the unshown insulating paper has been shown in the aforementioned first embodiment, the present invention is not restricted to this. The θ drive coil 42 and the Z drive coil 43 may be separately arranged in the single actuator without the insulating paper and may form one actuator as a whole. In this case, respective permanent magnets corresponding to the θ drive coil 42 and the Z drive coil 43 may be provided.

While the example of annularly arranging the single actuator 40 in the vicinity of the outer periphery of the stage 30 has been shown in the aforementioned first embodiment, the present invention is not restricted to this. The actuator may be arranged in a position inside the outer periphery of the stage.

While the example of dividing the Z drive coil 43 that is the example of the Z-direction drive coil into the three coil portions 43a, 43b, and 43c capable of being supplied with current independently of each other has been shown in the aforementioned first embodiment, the present invention is not restricted to this. The Z-direction drive coil of the actuator may be divided into four or more coil portions. It is only necessary to divide the Z-direction drive coil into at least three coil portions.

While the example of configuring the XYθZ stage 100 to be capable of finely adjusting the stage 30 to incline the stage 30 about an arbitrary axis in the horizontal plane by driving the three coil portions 43a, 43b, and 43c individually to control the height positions (height positions of the three points located at the rotation angular intervals of about 120 degrees as viewed in the direction Z) of the stage 30 at the positions A, B, and C corresponding to the coil portions 43a, 43b, and 43c, respectively has been shown in the aforementioned first embodiment, the present invention is not restricted to this. The XYθZ stage 100 may be configured to drive the stage only in the direction θx which is a rotation direction about an X-axis in the horizontal plane and the direction θy which is a rotation direction about a Y-axis orthogonal to the X-axis in the horizontal plane, not to drive the stage about an arbitrary axis in the horizontal plane.

While the example of arranging the three coil portions 43a, 43b, and 43c at the equal rotation angular intervals of about 120 degrees as viewed in the direction Z has been shown in the aforementioned first embodiment, the present invention is not restricted to this. The coil portions may be arranged at equal rotation angular intervals of an angle other than about 120 degrees or at rotation angular intervals different from each other.

While the example of forming each of the three coil portions 43a, 43b, and 43c in an arcuate shape as viewed in the direction Z and arranging the three coil portions 43a, 43b, and 43c in a circular (annular) shape has been shown in the aforementioned first embodiment, the present invention is not restricted to this. The coil portions may be formed in a shape other than the arcuate shape, such as a linear shape or an L shape, as viewed in the direction Z, or at least three coil portions may be arranged in a shape other than the circular shape, such as a rectangular shape.

While the example of forming each of the three coil portions 43a to 43c in the arcuate shape as viewed in the direction Z and forming each of the three coil portions 43a to 43c by stacking the six element coil portions (431 to 436) provided to correspond to three-phase power in the direction Z has been shown in the aforementioned first embodiment, the present invention is not restricted to this. The element coil portions may be formed in a shape other than the arcuate shape as viewed in the direction Z. Furthermore, the coil portions may be formed of three or nine element coil portions or the like other than the six element coil portions. Alternatively, the coil portions may not be formed of element coil portions, and coil portions having another structure may be employed.

While the example of providing the four magnet arrays in the movable element 40b has been shown in the aforementioned first embodiment, the present invention is not restricted to this. Only two magnet arrays of the first magnet array 45 made of the plurality of permanent magnets 49a aligned at the prescribed intervals (pitches p) along the circumferential direction throughout the entire circumference of the annular yoke 44 and the second magnet array 46 made of the plurality of permanent magnets 49b aligned at the prescribed intervals (pitches p) along the circumferential direction throughout the entire circumference of the annular yoke 44 may be provided.

While the example of providing the three up/down movement detecting portions (Z-direction position detecting portion) 50 to detect the positions of the stage 30 (elevating table 32) in the vertical direction (direction Z) at the positions (rotation angular positions) A, B, and C corresponding to the three coil portions 43a to 43c has been shown in the aforementioned first embodiment, the present invention is not restricted to this. Only one Z-direction position detecting portion to detect the position of the stage in the direction Z may be provided, and a detecting portion to detect the inclination of the stage may be provided separately.

While the example of providing the exhaust mechanism 80 in the θZ stage unit 110 has been shown in the aforementioned first embodiment, the present invention is not restricted to this. The exhaust mechanism may not be provided. Particularly when the θZ drive apparatus (stage apparatus) is employed to permit generation of particles, not as the stage to position an exposure apparatus, an inspection apparatus, or the like, it is not necessary to provide the exhaust mechanism.

While the example of providing the weight compensation portions 70 in the θZ stage unit 110 has been shown in the aforementioned first embodiment, the present invention is not restricted to this. The weight compensation portions may not be provided.

While the example of employing the spline 34a and the spline shaft 34b in the first guide portion 34 has been shown in the aforementioned first embodiment, the present invention is not restricted to this. For example, a ball bushing and a shaft may be employed in the first guide portion. In this case, the three second guide portions 35 stop the rotation of the elevating table 32 in the direction θz.

While the example of providing the first guide portion 34 and the three second guide portions 35 to guide the elevating table 32 has been shown in the aforementioned first embodiment, the present invention is not restricted to this. Only either the first guide portion 34 or the second guide portions 35 may be provided to guide the elevating table 32.

While the example of substantially annularly forming the permanent magnets 262 to 265 has been shown in the aforementioned second embodiment, the present invention is not restricted to this. The permanent magnets 262 to 265 may be constituted by a plurality of permanent magnets arranged at the same pitches p along the annular circumferential direction.

While the example of arranging the θ drive coil 245 inside the stator 241 has been shown in the aforementioned second embodiment, the present invention is not restricted to this. The θ drive coil 245 may be arranged outside the stator 241. Alternatively, the θ drive coil 245 may be arranged both inside and outside the stator 241. In these cases, the permanent magnets provided in the movable element 243 are constituted by a plurality of permanent magnets arranged at the same pitches p along the annular circumferential direction.

What is claimed is:

1. A θZ drive apparatus comprising:
a base portion;
a stage driven in a direction Z which is a vertical direction with respect to the base portion and in a direction θz which is a rotation direction employing the direction Z as a center line of rotation; and
a single actuator driving the stage at least in the direction Z with respect to the base portion, wherein
the single actuator includes a movable element having a plurality of permanent magnets and a stator provided to be opposed to the permanent magnets in a horizontal direction, having a Z-direction drive coil to drive the stage in the direction Z, and
the Z-direction drive coil of the single actuator is divided into at least three coil portions capable of being supplied with current independently of each other, while the at least three coil portions are arranged to be capable of driving the stage in the direction Z, a direction θx which is a rotation direction employing a direction X in a horizontal plane as a center line of rotation, and a direction θy which is a rotation direction employing a direction Y in the horizontal plane orthogonal to the direction X as a center line of rotation.

2. The θZ drive apparatus according to claim 1, further comprising at least three current supply control portions provided to correspond to the at least three coil portions constituting the Z-direction drive coil, respectively and supplying current individually to the at least three coil portions.

3. The θZ drive apparatus according to claim 2, further comprising at least three Z-direction position detecting portions provided to correspond to the at least three coil portions, respectively and detecting positions in the direction Z of portions of the stage corresponding to the at least three coil portions, respectively, wherein
the at least three current supply control portions are configured to control current supplied to the corresponding coil portions on the basis of results of position detection of the corresponding Z-direction position detecting portions.

4. The θZ drive apparatus according to claim 1, wherein
the at least three coil portions constituting the Z-direction drive coil each have an arcuate shape, as viewed in the direction Z and are circularly arranged along a circumferential direction to be electrically separated from each other.

5. The θZ drive apparatus according to claim 4, wherein
the at least three coil portions constituting the Z-direction drive coil each have an arcuate shape, as viewed in the direction Z and are formed by stacking at least three element coil portions provided to correspond to three-phase power in the direction Z.

6. The θZ drive apparatus according to claim 1, wherein
the at least three coil portions constituting the Z-direction drive coil are arranged at substantially equal rotation angular intervals.

7. The θZ drive apparatus according to claim 1, wherein
the stator of the actuator further includes a θz-direction drive coil to rotate the stage in the direction θz employing the direction Z as a center line of rotation in addition to the Z-direction drive coil,
the Z-direction drive coil and the θz-direction drive coil are integrally provided and annularly arranged, and
the actuator is configured to be capable of driving the stage in the direction Z, the direction θx, the direction θy, and the direction θz.

8. The θZ drive apparatus according to claim 7, wherein
the Z-direction drive coil and the θz-direction drive coil are integrally bonded to each other through an insulator.

9. The θZ drive apparatus according to claim 7, wherein
the permanent magnets constituting the movable element of the actuator include:
a first magnet array including a plurality of first permanent magnets arranged at substantially the same pitch intervals along an annular circumferential direction, in which surfaces of portions opposed to the Z-direction drive coil and the θz-direction drive coil have first polarity, and
a second magnet array including a plurality of second permanent magnets adjacent to the first magnet array in the direction Z and arranged at substantially the same pitch intervals along the annular circumferential direction, in which surfaces of portions opposed to the Z-direction drive coil and the θz-direction drive coil have second polarity different from the first polarity, and
the plurality of first permanent magnets constituting the first magnet array and the plurality of second permanent magnets constituting the second magnet array are arranged to appear alternately along the circumferential direction, as viewed in the direction Z.

10. The θZ drive apparatus according to claim 1, wherein
the actuator is annularly arranged in the vicinity of an outer periphery of the stage.

11. The θZ drive apparatus according to claim 1, wherein
the Z-direction drive coil is constituted by three coil portions capable of being supplied with current independently of each other.

12. The θZ drive apparatus according to claim 1, wherein
the permanent magnets which the movable element has include an inner permanent magnet provided inside the movable element and an outer permanent magnet provided outside the movable element, and
the Z-direction drive coil which the stator has includes an inner Z-direction drive coil provided to be opposed to the inner permanent magnet and an outer Z-direction drive coil provided to be opposed to the outer permanent magnet.

13. The θZ drive apparatus according to claim 12, wherein
the inner permanent magnet includes first permanent magnets arranged along an annular circumferential direction, in which surfaces of portions opposed to the inner Z-direction drive coil have first polarity and second permanent magnets adjacent to the first permanent magnets in the direction Z and arranged along the annular circumferential direction, in which surfaces of portions opposed to the inner Z-direction drive coil have second polarity different from the first polarity, and
the outer permanent magnet includes third permanent magnets arranged along the annular circumferential direction, in which surfaces of portions opposed to the outer Z-direction drive coil have first polarity and fourth permanent magnets adjacent to the third permanent magnets in the direction Z and arranged along the annular circumferential direction, in which surfaces of portions opposed to the outer Z-direction drive coil have second polarity different from the first polarity.

14. The θZ drive apparatus according to claim 13, wherein
the stator of the actuator further includes a θz-direction drive coil to rotate the stage in the direction θz employing the direction Z as a center line of rotation in addition to the Z-direction drive coil,
a plurality of the first permanent magnets are provided and arranged at substantially the same pitch intervals along the annular circumferential direction to constitute a first magnet array while a plurality of the second permanent magnets are provided and arranged at substantially the same pitch intervals along the annular circumferential direction to constitute a second magnet array, and
the plurality of first permanent magnets constituting the first magnet array and the plurality of second permanent magnets constituting the second magnet array are arranged to appear alternately along the circumferential direction, as viewed in the direction Z.

15. The θZ drive apparatus according to claim 13, wherein
the third permanent magnets and the fourth permanent magnets are substantially annularly formed.

16. A stage apparatus comprising:
a θZ drive portion;
an X-direction drive portion driving the θZ drive portion in a direction X in a horizontal plane; and
a Y-direction drive portion driving the θZ drive portion in a direction Y in the horizontal plane orthogonal to the direction X, wherein
the θZ drive portion comprises:
a base portion,
a stage driven in a direction Z which is a vertical direction with respect to the base portion and in a direction θz which is a rotation direction employing the direction Z as a center line of rotation, and
a single actuator driving the stage at least in the direction Z with respect to the base portion,
the single actuator includes a movable element having a plurality of permanent magnets and a stator provided to be opposed to the permanent magnets in a horizontal direction, having a Z-direction drive coil to drive the stage in the direction Z, and
the Z-direction drive coil of the single actuator is divided into at least three coil portions capable of being supplied with current independently of each other, while the at least three coil portions are arranged to be capable of driving the stage in the direction Z, a direction θx which is a rotation direction employing the direction X in the horizontal plane as a center line of rotation, and a direction θy which is a rotation direction employing the direction Y in the horizontal plane orthogonal to the direction X as a center line of rotation.

17. The stage apparatus according to claim 16, further comprising at least three current supply control portions provided to correspond to the at least three coil portions constituting the Z-direction drive coil, respectively and supplying current individually to the at least three coil portions.

18. The stage apparatus according to claim 17, further comprising at least three Z-direction position detecting portions provided to correspond to the at least three coil portions, respectively and detecting positions in the direction Z of portions of the stage corresponding to the at least three coil portions, respectively, wherein
the at least three current supply control portions are configured to control current supplied to the corresponding coil portions on the basis of results of position detection of the corresponding Z-direction position detecting portions.

19. The stage apparatus according to claim 16, wherein
the at least three coil portions constituting the Z-direction drive coil each have an arcuate shape, as viewed in the direction Z and are circularly arranged along a circumferential direction to be electrically separated from each other.

20. The stage apparatus according to claim 19, wherein
the at least three coil portions constituting the Z-direction drive coil each have an arcuate shape, as viewed in the direction Z and are formed by stacking at least three element coil portions provided to correspond to three-phase power in the direction Z.
